(19) United States
(12) Patent Application Publication
(10) Pub. No.: US 2004/0233618 A1
(43) Pub. Date: Nov. 25, 2004

(54) Handling banknotes and the like

(76) Inventors: Kevin Ashurst, Birkby (GB); Martin Sackfield, Manchester (GB)

Correspondence Address: Timothy W Hagan, Dinsmore & Shohl, Suite 500 One South Main Street, One Dayton Centre, Dayton, OH, 45402-2023, US

(21) Appl. No.: 10/485,609

(22) PCT Filed: Jul. 30, 2002
(86) PCT No.: PCT/GB02/03458

(30) Foreign Application Priority Data
Jul. 30, 2001 (GB) 0118531.3

(51) Int. Cl. H02B 1/00

(52) U.S. Cl. 361/600

(57) ABSTRACT

A banknote validator (50) for receiving and accepting valid banknotes is described. The banknote validator (50) comprising a housing (54) comprising banknote sensing means (136) and a separable banknote drive mechanism (60) for conveying the banknote into the validator (50) to the sensing means (136), wherein the banknote drive mechanism (60) is arranged to be readily removable such that a faulty drive mechanism can be rapidly replace. The banknote validator also comprises a housing including a sensor housing body and a sensor for sensing a characteristic of a banknote in use to determine its validity provided within the sensor housing body. The sensor housing body (54) comprises a one-piece translucent moulded portion (140) defining a banknote-engaging surface (150) along a note path (61) of the validator (50) and an opaque portion provided adjacent the sensor and arranged such that in use illumination of the banknote is sensed by the sensor without substantial interference from ambient light.

### FIELD OF THE INVENTION

This invention relates to the handling and validating of flexible sheets of monetary value, notably banknotes handled by systems such as vending machines, gaming machines, payments machines and banknote dispensers.

For convenience, banknotes will be used an example of such sheets throughout this specification. The term banknote will also be used to encompass other items of money's worth that have detectable features requiring validation, such as tickets and vouchers.

### BACKGROUND TO THE INVENTION

A machine that receives and handles banknotes typically includes a validator that verifies a banknote upon insertion by checking its authenticity and condition and rejecting it if it is deemed invalid. An example of a validator is disclosed in our International Patent Application WO-A-93/07590. Once validated, the banknote typically passes from the validator into a secure long-term store, such as a removable cassette-type stacker or a cashbox within the machine. An example of a stacker is disclosed in our European Patent Application EP-A-0 983 952. Once in a long-term store, a validated banknote typically cannot be removed by or dispensed to the user: it can only be removed from the machine when, for example, the stacker is replaced or the cashbox is emptied by a person maintaining or servicing the machine.

A banknote validator defines at least part of a note path beginning with a slot through which a banknote is inserted and ending at the secure long-term store. On sensing insertion of a banknote, a drive mechanism inside the validator is activated, drawing the banknote into the validator and past sensors that determine certain characteristics, including the validity, of the banknote. If the banknote is deemed acceptable, it is guided by the drive mechanism along the note path into the cashbox. Otherwise, the drive mechanism is reversed and the banknote is returned to the user.

A drive mechanism typically comprises at least one pair of wheels or rollers that co-operate to grip the banknote. The two rollers in each pair are located adjacent to one another and are driven by a motor. Either both rollers in each pair are motorised or only one roller is motorised. In the latter case, the second roller in the pair is a ‘reaction’roller or idler wheel that rotates in response to rotation of the motorised roller.

Referring to FIG. 1, the drive mechanism 10 may also take the form of a tensioned motorised belt 12 that is moved between pairs of wheels 14 located on either side of the belt 12. In such an arrangement, gripping of the banknote may be achieved by spring-loading the wheels (pressure wheels) 16 on one side of the belt so that they bear on the belt 12 and on the other wheels (reaction wheels) 18. In such an arrangement, the reaction wheels 18 are essential to prevent the belt 12 jamming against an internal banknote-conveying surface (not shown) of the validator, thereby preventing the note path from being impeded. A driven wheel 20 is also provided which is connected to a drive motor and gears. Furthermore, to maintain tension in the belt 12, a spring-loaded belt-tensioning wheel 22 is also provided.

U.S. Pat. No. 6,076,826 describes a document validator having a portion of a sub part of its transport mechanism which is removable. Here, the removal of an axle from between two support plates is enabled by the provision of slots in each of the support plates. This facilitates easier deconstruction of the transport mechanism to remove a worn belt than was previously possible. However, because most of the transport mechanism remains in the validator and disassembly of a portion of its sub part is still a technical task, this solution does not make the task of servicing a validator non-technical. This is evidenced by the fact that specialist tools are required to remove the circlips that retain the axle in the slots in the plates during normal use.

The validation portion of a validator comprises sensors for determining certain characteristics of banknotes. For example, light sources, such as light emitting diodes (LEDs), may be used to illuminate the banknote at particular wavelengths, while light receivers may be provided to receive the light transmitted through or reflected from the banknote. The magnetic signature of a banknote may also be sensed by suitable magnetic sensors. The characteristics of the banknote are then compared with expected characteristics for a valid banknote to determine whether the banknote under test is valid.

It will be appreciated that maintaining a clean environment around the validation sensors is important to ensure correct and repeated validation of banknotes. However, the ingress of dirt and water, together with ambient light, pose a significant problem when designing validators, since the validation sensors are typically close to the note insertion slot and therefore close to the potentially contaminating environment.

To reduce ambient light interfering with the reception of light by the light receivers, the validator housing may be transparent to a particular colour, such as red. Ambient light of wavelengths other than that colour will be absorbed and not detected by the light receivers. However, this limits the wavelengths that may be used to validate a banknote. More typically, the housing is opaque or black which absorbs substantially all visible wavelengths and provides the best suppression of ambient light. However, since light cannot be transmitted through such housings, openings must be provided to enable the passage of light from the light sources and to the light receivers. Such openings allow dirt, water and air to contact the sensitive optics, interfering with measurements and degrading the components.

Referring to FIG. 2, a known solution to the above problem is shown. Here, to protect the optics, a clear plastics window 30 is provided over each opening 32, together with a separate lens 34 to focus and guide the light to a sensor 36 mounted in a printed circuit board 38. Such a window 30 is typically a snap fit within the corresponding opening 32 in the housing 40. A particular problem with these snap-fit windows 30 is that water and dirt may easily get in between the housing 40 and the window 30, particularly when subjected to varying temperature conditions which can cause differential expansion or contraction of the plastics windows 30 and housings 40. Furthermore, the windows 30 do not always fit flush with the surrounding housing 40, providing an area that can collect dirt and interfere with the leading edge of the banknote as it is advanced along the note path defined by the top surface 42 of the housing.

International patent application WO-A-96/23282 seeks to overcome the problems of the snap-in windows and describes a validator in which a transparent plastic window is moulded into and fused with a black plastics housing. However, the Applicant has found that such mouldings suffer from the same problems as the snap-in windows, though to a lesser degree. However, such moulded windows are far more complicated and costly to manufacture.

Dirt and water will also interfere with the note path and affect the note moving mechanisms, such as wheels or rollers of a drive mechanism, within a validator. Since these mechanisms are typically constructed from many small parts, including balanced springs and the like, destruction by the environment or vandalism, as well as general wear and tear on the validator, requires a user to send a validator away to be serviced. This is highly undesirable from a cost and time perspective.

Accordingly, an aim of the present invention is substantially to overcome the problems of the known validation machines. In particular, the invention aims to provide a validator that is reliable, easy to assemble and simple to maintain and repair.

### SUMMARY OF THE PRESENT INVENTION

From one aspect, the present invention resides in the simple appreciation that by separating the drive mechanism from the banknote validator, it is possible to achieve significant benefits over the existing prior art devices. More specifically, the present invention provides a banknote validator having a readily removable drive mechanism, which can be replaced without having to replace the entire validator or without first having to remove the belt from the drive mechanism. It is to be appreciated that the term ‘drive mechanism’ includes at least one drive belt. The drive mechanism is preferably a cassette unit that defines a note path from the validator to a secure long-term store. The cassette unit preferably comprises drive wheels and a drive belt against which reaction wheels provided in the non-removable portion of the validator act against in use to grip banknotes. An electrical motor and gears used to power the drive wheels are preferably incorporated in the cassette.

The provision of a cassette enables an extremely compact and elegant combination of a validator and secure long-term store to be provided. One side of the cassette adjacent the non-removable portion of the validator is provided for guiding the banknote along the note path, whereas the other side of the cassette is provided adjacent the store such that notes are automatically released by reaching a note storage position. The simplest way of achieving this is to provide an endless belt that defines the whole note path around the cassette. Preferably, two such endless belts are provided spaced apart to minimise the contact surface area with the banknote whilst maintaining a secure grip advantageously of the note during its transport along the note path. Accordingly, removal of the cassette provides automatic removal of the belts without the need for disengagement of the belts from the drive mechanism. As the most common reason for servicing of a validator is the need to replace a worn belt, it can be seen that servicing becomes far easier using the present invention.

The drive mechanism can be accessible by hinging the non-removable part of the validator to the secure long-term store such that hinged movement between these parts effectively opens the combination to allow removal and replacement of the drive mechanism. This also advantageously enables the secure long-term store to be accessed in a simple manner for removal of its collected banknotes.

The present invention also addresses the issue of the complicated nature of the existing solutions to gripping the banknote securely and reliably whilst at the same time transporting the banknote along the note path. The present inventors have appreciated that it is not necessary to have a plurality of pairs of drive/reaction wheels along the note path to ensure reliable transport. Rather, the same reliability can be achieved by imparting a tension into a resilient endless belt and using that tension to provide a sufficient gripping force between the belt and reaction wheels to transport the banknote along the note path.

More specifically, the endless belt can be deflected from its natural position to use the tension in the belt to generate a gripping force at a direction perpendicular to the movement of the belt (the note path). This gripping force needs ideally to be substantially constant along the portion of the note path where the note is to be gripped. However, the greater the distance from a drive belt guide wheel in the readily removable drive mechanism, the greater the deflection of the belt that is required to maintain a substantially uniform gripping force. Accordingly, the note path is preferably curved such that the endless belt can be deflected along this path to generate a constant gripping force. This may be realised by having a curved surface of the removable drive mechanism adjacent the non-removable portion of the validator and a means for deflecting the belt towards the curved surface to generate the desired uniform gripping force.

Preferably, the non-removable portion of the validator has a note guiding surface that has a matching profile to that of the curved surface of the removable drive mechanism such that the note is guided smoothly between its gripping points, namely at the fixed reaction wheels.

Preferably the removable drive mechanism has two drive belt guide wheels. This minimises the number of wheels required in the drive mechanism to its minimum thereby simplifying the design and subsequent maintenance. Preferably, one of these wheels is a driven wheel and the other wheel is a reaction wheel. One of these wheels preferably has a spring-loaded axis which enables the endless belt to be deflected out of its natural path to provide the required tangential gripping force. The other wheel can then be fixed.

The present invention also extends to solving the problems associated with ambient light interference, snap-fit windows and moulded and fused windows. In this regard, the present invention provides a banknote validator that has a body and sensing means for sensing a characteristic of a banknote in use to determine its validity. A one-piece moulded portion of the body which defines a banknote engaging surface along a note path is transparent and another portion of the body provided adjacent the sensing means is opaque and arranged such that illumination of the banknote is sensed without substantial interference from ambient light. By this simple reversal of priorities, substantial benefits can be obtained in that moulded and fused windows are not required thereby reducing the manufacturing costs and the problems with non-homogeneous banknote engaging surfaces of the prior art. The opaque portion of the body can be arranged in many different ways to ensure that ambient light passing through the transparent banknote-engaging surface does not reach the sensing means but that controlled banknote illumination does. Further opaque portions of the body can be provided facing away from the note path to prevent ambient light entering the validator. In the case, the translucent portions would face the note path. To enhance to controlled banknote illumination received by the sensing means, the opaque portion may have reflecting means provided around the reflection/refraction/absorption light path from the banknote to the sensing means.

### BRIEF DESCRIPTION OF THE DRAWINGS

In order that the invention may be more readily understood, reference will now be made, by way of example, to the accompanying drawings in which:

FIG. 1 is a schematic diagram showing a belt-driven drive mechanism known from the prior art;

FIG. 2 is an exploded part cross-section diagram illustrating the top of the note path, a clear “snap-in” window, a lens and a sensor mounted on a printed circuit board known from the prior art;

FIG. 3 is a perspective view of an opened validator in accordance with a presently preferred embodiment of the present invention with a drive mechanism cassette visible;

FIG. 4 is a perspective view of the drive mechanism cassette of FIG. 3;

FIG. 5 is a side view of the drive mechanism cassette of FIG. 3 including internal details in dashed lines;

FIG. 6 is a plan view of the drive mechanism cassette of FIG. 3 from above with one drive belt removed;

FIG. 7 is a plan view of the underside of a panel providing the lower face of the lid of the validator shown in FIG. 3;

FIG. 8 is a side view of the panel of FIG. 7 showing its curved profile; and

FIG. 9 is a schematic diagram showing the drive mechanism cassette of FIG. 3 in combination with the panel of FIGS. 7 and 8 in use.

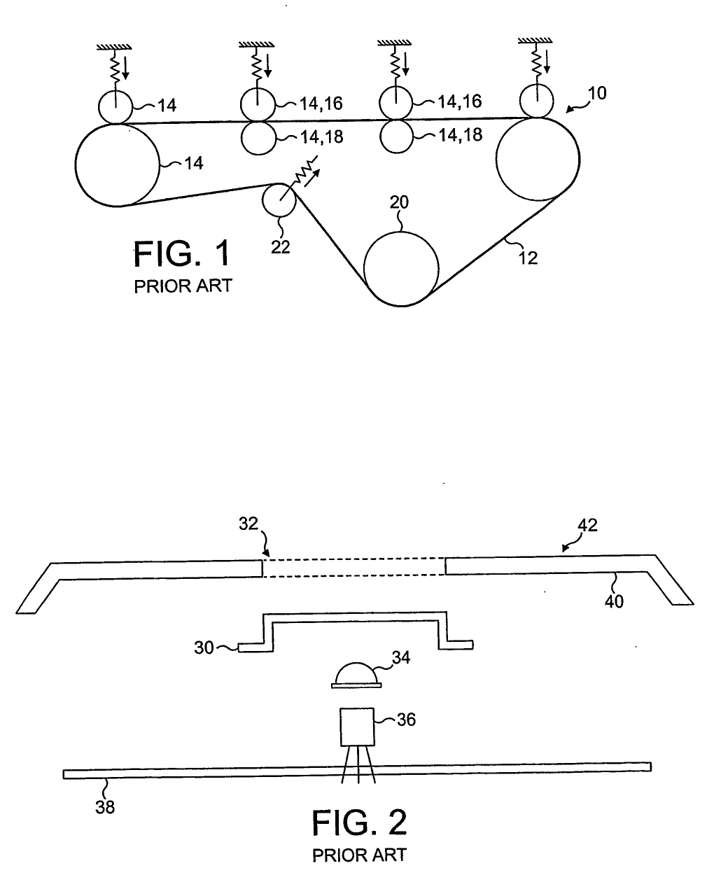

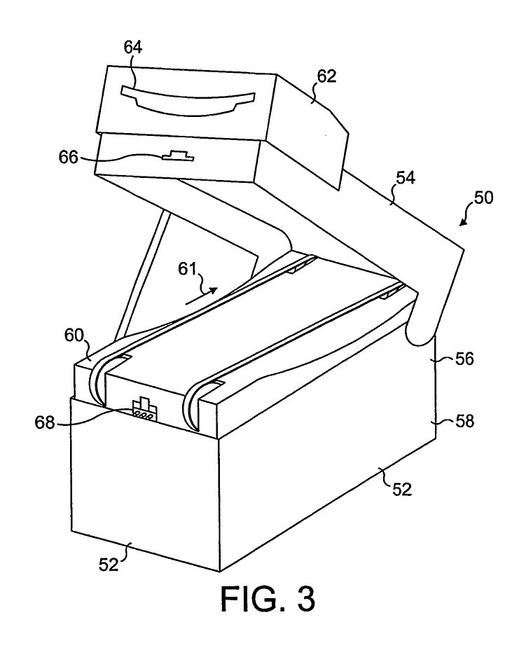

### DETAILED DESCRIPTION OF A PRESENTLY PREFERRED EMBODIMENT OF THE PRESENT INVENTION

In essence, a banknote validator accepts a banknote through an opening, whereupon the banknote is moved along a note path, past validation sensors and the like, before being accepted and passed to a storage point or rejected and returned to the user.

The disclosures of International Patent Application WO-A-93/07590 and European Patent Application EP-A-0 983 952 are incorporated herein by reference.

Referring firstly to FIG. 3 of the drawings, a banknote validator 50 in accordance with the preferred embodiment of the present invention takes the form of a substantially cuboid box defining six oblong faces 52 and being divided into a lid 54 hingedly connected to a body 56. The body 56 of the box houses a cash box 58 for storing banknotes (not shown), on top of which is located a removable drive mechanism 60 of the validator 50. The surfaces of the drive mechanism 60 in co-operation with the adjoining surface of the lid define a note path 61 through the validator 50.

The lid 54 of the box accommodates most of the electronic circuitry of the validator, such as sensors, for validating banknotes, together with associated power supplies and circuitry, whose design is within the scope of the skilled reader and so will not be described here. The lid 54 also includes a cover 62, referred to in the trade as a ‘bezel’. The bezel 62 fits over one end of the lid 54, extends along part of the length of the lid and includes an opening 64 in its upper surface to allow insertion of a banknote into the validator 50. The bezel 62 is moulded from a translucent plastics material so that illuminated instructions are visible to the user through the bezel. In addition, the lid 54 includes a sliding catch 66, which enables the lid to be secured in its closed position.

When closed, the lid 54 and body 56 co-operate to enclose the drive mechanism 60 and to provide a substantially tamper-resistant seal to prevent unauthorised removal of banknotes stored in the cashbox 58. Removal of the drive mechanism involves the release of catch 68 which otherwise secures the drive mechanism 60 in the body 56.

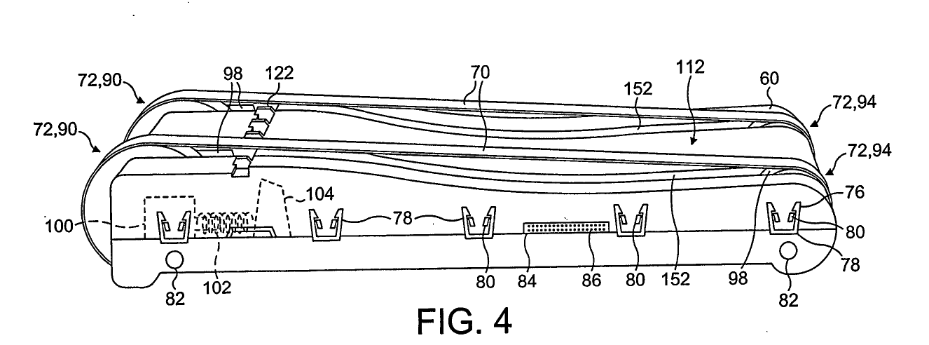

Turning to FIGS. 4, 5 and 6, the drive mechanism 60 shown is a modular unit in the form of a replaceable cassette 60. The length and width of the cassette 60 are such that the cassette fits snugly within the lid and body of the validator 50. The cassette 60 is secured in position by the releaseable catch 68, which has been described above. The cassette has a pair of endless removable, flexible drive belts 70 which are spaced apart to cover the width of the cassette by wheels 72 provided at either end of the cassette 60. These wheels 72 are described in detail later.

As will be described below, the depth of the cassette 60 varies along its length but is sufficient to accommodate motors, gears and circuitry (not shown) for moving banknotes along the note path 61. Also simple optics, illumination light sources and the like required for banknote validation are also provided, though the majority of electronics required for validation are provided in the lid 54 of the validator 50. In use, the upper surface of the top face of the cassette 60 provides a significant portion of one side of the note path 61 while the corresponding other side of the note path 61 is provided by the lower face of the lid of the validator 50 (described later). The note path 61 continues around the cassette 60 to the cash box 58 where validated banknotes are stored (not shown).

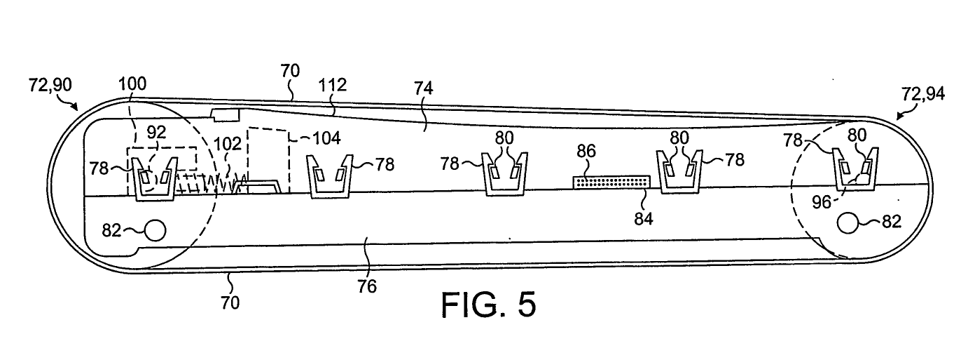

As shown clearly in FIG. 5, the cassette 60 is divided into a top 74 and a base 76 along the cassette's length. The top 74 and base 76 are held together by pairs of flexible fingers 78 located on the base 76 that snap-fit around pairs of projections 80 on the top 74, as well as co-operating male and female projections (not shown) at either ends of the cassette 60.

The base 76 has two pairs of cylindrical lugs 82, one at each end of the sides of the cassette 60. In use, the lugs 82 co-operate with corresponding slots (not shown) in the body 56 of the validator 50 to locate the cassette 60 over the cashbox 58. An opening 84 in one side of the cassette 60 allows a removable cable (not shown) with a female connector to be fed into the cavity of the cassette 60 and connected to the male connector 86 provided therein. This cable connection enables power and drive signals to be supplied to the cassette 60 from the body 56 of the validator 50.

The cassette 60 has two pairs of wheels 72, one pair 90 located at one end of the cassette 60 on a first common axle 92 and the other pair 94 located at the opposite end on a corresponding second common axle 96. Each wheel 72 is housed in a slot 98, the length of which extends parallel to the long sides of the cassette 60 and the depth of which mirrors that of the cassette 60.

The first pair of wheels comprise reaction or idler wheels 90 whose diameter is greater than the depth of the cassette 60 such that the wheels 90 protrude above, below and beyond the respective end of the cassette 60. The idler wheels 90 are spring mounted independently of each other within the cassette 60 by the first axle 92 being mounted within a movable block 100 provided at each end of the axle 92 within the cassette 60. Each movable block 100, and hence the first axle 92, is coupled to the cassette 60 by an independent respective spring 102. The other end of each spring is fixed to a pillar 104 moulded inside the cassette top 74. Movement of the idler wheels 90 in and out of the slot 98 is limited by a stop (not shown) moulded into the cassette top 74 and by an end wall of the cassette base 76.

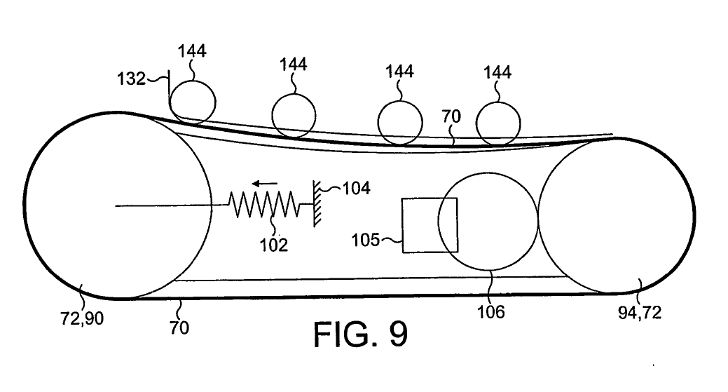

The second pair of wheels 94 is located opposite the first pair 90. Unlike the first pair 90, the second pair 94 have a diameter that is approximately equal to the depth of the cassette 60 such that the circumference of the wheels 72, 94 is substantially flush with the upper and lower surfaces of the cassette. The corresponding end of the cassette 60 is semi-circular in shape, following the curvature of the wheels' circumference such that banknotes can be transported smoothly around the end of the cassette along the note path 61 to the cashbox 58. The second pair of wheels 94 is driven by a motor 105 (See FIG. 9) located inside the cassette 60 via a drive wheel 106 mounted on the second axle 96.

The protrusion of the first pair of wheels 90 is to enable a user to push the wheel 90 manually against the action of the springs 102 to enable removal of the endless belts 70 for repair. Also the difference in size between the first 90 and second 94 pairs of wheels provides a desired gap between the belts 60 and the note path-defining surface of the cassette 60.

Each wheel 72 in the first pair 90 is linked to an opposite wheel 72 in the second pair 94 by one of the two endless drive belts 70. It will be appreciated that two drive belts are provided for the two wheels 72 in each pair 90, 94. In use, rotation of the second pair of wheels by the motor 105 is transferred to the first pair 90 of wheels via the drive belts 70.

Each drive belt 70 is moulded from a flexible, resilient but substantially non-elastic plastics material and has a circumference that when fitted to the cassette 60 exerts a degree of pressure on the spring-loaded idler wheels 90 so that the wheels 90 rest at an intermediate position between the ends of travel of the axle 92, namely at an intermediate position of the idler wheels 90 within their respective slots 98. In this way, the resilience of the springs 102 push the idler wheels 90 against the belts 70 to hold the belts 70 on the idler wheels 90 and to provide a desired tension within each belt 70. To remove one of the belts 70, the spring-loaded idler wheel is simply pushed into the slot 98, towards the cassette 60, to relieve the pressure against the belt 70 so that the belt 70 may be pulled clear of the idler wheel 90. This is of particular importance for ease of maintenance as worn belt replacement is one of the most common validator faults that requires repair.

To aid location of each belt 70 and to prevent each belt from slipping off in use, the wheels 72 of both pairs 90, 94 have grooves 108 moulded into their circumferential edges. These grooves 108 correspond with ridges (not shown) moulded into the underside of the belts 70.

The upper surface of each belt 70 has a series of notches 110 spanning the width of the belt and perpendicular to the length of the belt to aid the belt in its travel around the circumference of the wheels 72 and to present a gripping surface to a banknote.

As mentioned above and referring in particular to FIG. 5, the depth of the cassette 60 varies along its length, an upper surface 112 of the top 74 sloping downwards from the first pair 90 of wheels, where the cassette 60 is deeper, to the second pair 94 of wheels. The profile of the end of the cassette with the first pair 90 of wheels is square while, as mentioned above, the opposite end is semi-circular in shape, following the curvature of the second pair 94 of wheels.

A lower surface 120 of the base 76 is essentially straight and is indented along the majority of its length from the points at which the drive belt 70 leaves the circumferences of the wheels 72 at each end. Within this indentation, a pusher foot mechanism (not shown) is provided to put a banknote that has reached the cashbox part of the note path 61 under a slight pressure towards the cashbox 58.

At the idler wheel end of the cassette 60, the upper surface 112 of the top 74 has a straight portion before rising by way of a series of elongate moulded projections 122 located across the width of the top 74 at the ends of the slots 98 where the idler wheels 90 disappear into the cassette body. These elongate projections 112 assist in stopping undesirable objects from being inserted into the banknote validator 50 whilst at the same time assisting in guiding the banknotes into the note path 61 of the validator 50. The upper surface 112 then slopes downwards by approximately 4 degrees to the mid-point of the cassette 60 where the slope levels out before sloping up slightly at the end to accommodate the second pair 94 of wheels. The concave curvature of the top 74 thereby creates a gap between its upper surface 112 and the grooved underside of the drive belts 70 when the cassette 60 is disassembled from the validator 50. As mentioned previously, the degree of curvature and hence the amount of the gap at any given point is dependent on the amount of deflection required to produce a generally uniform gripping force along the note path 61. Generally speaking, the further away from the belt supporting wheels 72 that a point on a belt 70 is, the greater the deflection required to generate the same gripping force purely from the tension in the drive belts 70. This force is substantially at right angles to the direction of travel of the belt 70 in its operation.

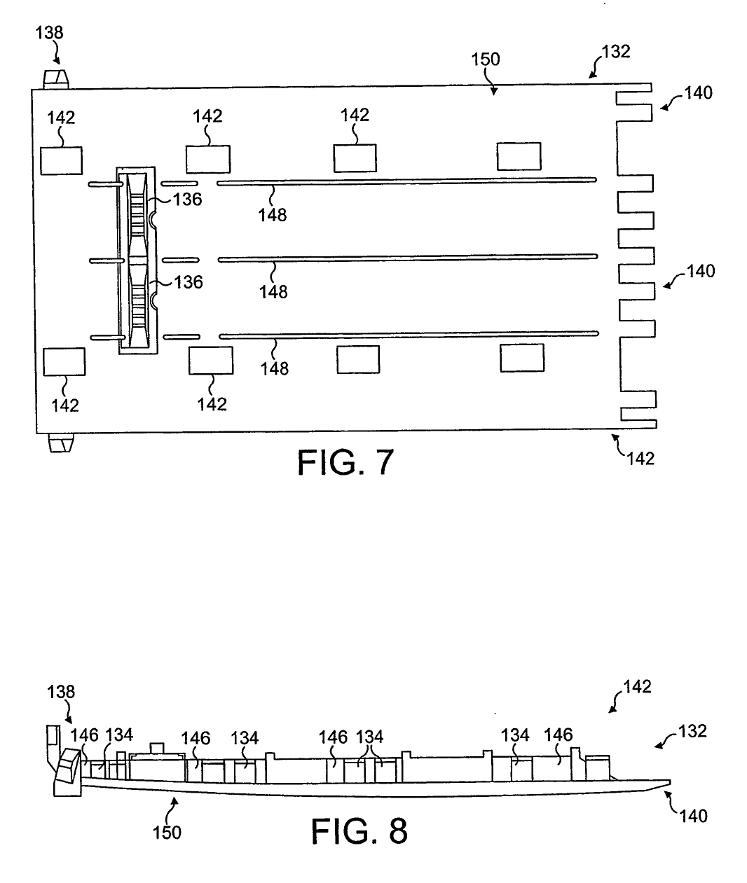

Turning to FIGS. 7 and 8, a corresponding portion of the note path 61 is completed by the lower face 130 of the lid 54 of the validator 50 which, in accordance with an aspect of the present invention, comprises a translucent oblong panel 132 that is fixed inside the lid by way of flexible tabs 134. The width of the panel 132 is equivalent to the width of the cassette 60 while the length is approximately the length of a banknote. The translucent panel 132 has a built-in moulded lens 136 and light guides 136 provided which are described in detail later.

A raised curved end 138 of the panel 132 is located towards the opening 64 in the bezel 62 and the first pair 90 of wheels, and guides a banknote inserted through the opening 64 along the note path 61. The curved end 138 together with the elongate projections 122 on the upper surface 112 of the drive mechanism cassette 60, present a smooth surface to an incoming banknote and aid its passage through and along the note path 61. The castellate projections 140 at the opposite end 142 aid location and fixing of the panel 132 into the lid 54.

The panel 132 has a curvature that mirrors that of the upper surface 112 of the drive mechanism cassette 60 and has a series of four pairs of oblong openings 142 that are positioned in parallel along the length of the panel 132. These openings are positioned to allow four pairs of fixed reaction wheels 144 (see FIG. 9) to project through the panel 132, such that each wheel 144 rests on a drive belt 70. Each opening 142 is bordered by a raised wall 146 that acts as a housing for each wheel 144.

In use, the reactive wheels 144 rest on the drive belts 70 deflecting the belts 70 from their preferred straight-line position between the idler wheels 90 and the drive wheels 94 to a curved position therebetween. Since the belts 70 are held around the cassette 60 under tension, deflection of the belts towards the upper surface 112 of the cassette 60 results in a reactive force (gripping force) from the belts 70 in a direction away from the upper surface creating a pinch point or nip where each reaction wheel 144 meets the belt 70. The tension in the belts 70 replaces the need for a spring-loaded reaction wheel to create the nip as well as further reaction wheels to aid movement of the belts 70 along the note path 61.

Insertion of a banknote into the validator 50 breaks a continuous beam (not shown) positioned before the first pair 90 of wheels in the cassette 60. Breaking of the beam activates the motor (not shown) that drives the second pair 94 of wheels causing the drive belts 70 to be moved and, in turn, rotating the first pair 90 of wheels. Movement of the drive belts 70 also rotates the reaction wheels 144 bearing on the belts 70 from the lid 54 so that the leading edge of the banknote is pulled into the note path 61 by the moving drive belt 70. The banknote is gripped between the upper reaction wheels 144 and the belts 70 so that it is driven along the note path 61 and past validation sensors (not shown) provided in the lid 54.

Ridges 148 running along the length of the upper surface 112 of the cassette 60 and the note contact surface 150 of the lid panel 132 create a small space between a banknote and the surfaces of the note path 61. This space prevents the banknote from jamming against the surfaces 112 and any dirt that may have entered the validator 50 from impeding the travel of the banknote. Also, grooves 152 are located in the upper surface 112 of the cassette 60, under the drive belts 70, to maximise the gap between the cassette surface 112 and the underneath surface of each belt 70. The grooves 152 also maximise the possible degree of allowable deflection of the belts 70, as well as allowing space so that any dirt does not impede the travel of the belt 70.

The cassette 60 and the lid panel 132 are moulded from a synthetic plastics material such as polycarbonate. The base 56 of the cassette 60 is an opaque or black colour while the top 74 of the cassette 60 and the lid panel 132 are transparent and colourless. They are also moulded as single, continuous pieces.

Referring now to FIG. 9, a schematic representation showing the drive mechanism cassette of FIG. 3 is used in combination with the panel of FIGS. 7 and 8. As can be seen, the reaction wheels 144 of the lid pass through the oblong openings 142 to engage the drive belts 70. The gripping force generated by the curved deflected drive belts 70 is substantially uniform along the length of the upper surface 122 of the cassette.

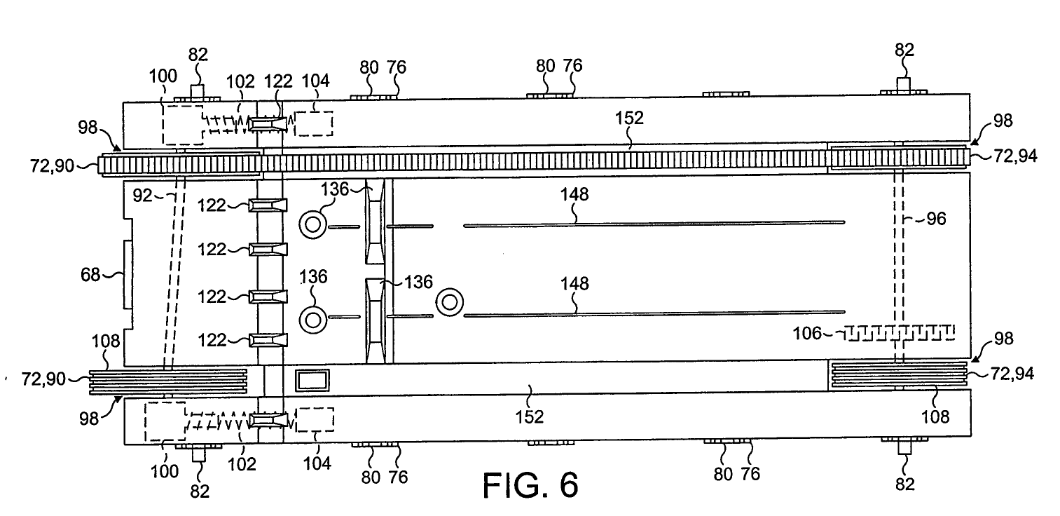

Returning to FIGS. 6 and 7, the transparent mouldings (the top 74 of the cassette 60 and the lid panel 132) include integral light guides 136 and lenses 136 in positions that correspond to light sources (not shown) and receivers (not shown) mounted on printed circuit boards (not shown) located within the cassette 60 and lid 54. In particular, it can be seen that light guides 136 located in the cassette 60 correspond in position to identical light guides 136 in the lid panel 132. Suitable sensors and circuitry to obtain light transmission, reflection and refraction characteristics from the banknote are deemed to be within the scope of the skilled man and so will not be described herein.

Light sensitive optics in the lid 54 are encased in an opaque housing that fits over the light guides and is located on locator pins integrally moulded into the lid panel 132. Light sensitive optics located in the cassette are also shielded by the opaqueness of the base 76 of the cassette 60.

It will be apparent that the drive mechanism cassette 60 is a self-contained modular unit that may be inserted into and removed from a validator 50 with relative ease. The cassette 60 also has the minimum number of small moving parts that are liable to fail. In this respect, the changing of a belt is a simple and fast operation not requiring any tools. If the cassette requires more complicated servicing, it may simply be removed and replaced by an identical cassette while the original cassette is being serviced thereby radically minimising the amount of time that a validator is inoperable. The replacement is also a simple operation as has been described. The integral moulding of lenses 136 and light guides 136 also makes this possible since the drive mechanism cassette 60 does not require skilled removal and replacing of sensitive optical equipment.

Having described a preferred embodiment of the present invention, it is to be appreciated that the embodiment in question is exemplary only, and that variations and modifications, such as those which will occur to those possessed of the appropriate knowledge and skills, may be made without departure from the spirit and scope of the invention as set forth in the appended claims. For example, whilst lenses and light guides have been mentioned in general, it is also possible to incorporate any optical element into the once-piece moulded construction such as a prism.

1-35. (cancelled)

36. A banknote validator for receiving and accepting valid banknotes, the banknote validator including: a housing comprising banknote sensing means; and a separable banknote drive mechanism for conveying the banknote into the validator to the sensing means; wherein the banknote drive mechanism is arranged to be readily removable such that a faulty drive mechanism can be rapidly replaced.

37. A banknote validator of claim 36, wherein the banknote drive mechanism comprises a removable cassette unit.

38. A banknote validator of claim 37, wherein the cassette unit defines a note path from the validator to a secure long term store.

39. A banknote validator of claim 38, wherein the cassette unit comprises drive wheels and a drive belt and the housing comprises reaction wheels which react against the drive belt in use to grip banknotes.

40. A banknote validator of claim 38, further comprising a secure long-term store, wherein one side of the cassette is provided adjacent the non-removable housing for guiding the banknote along the note path, and another side of the cassette is provided adjacent the secure long-term store such that banknotes are automatically released by reaching a note storage position along the note path.

41. A banknote validator of claim 40, wherein the cassette unit comprises an endless drive belt which defines the whole note path around the cassette unit.

42. A banknote validator of claim 40, wherein the cassette unit comprises two spaced apart endless belts.

43. A banknote validator of claim 40, wherein the housing comprises a hinge between the secure long-term store and the banknote sensing means and the drive mechanism is accessible by hinged movement of the non-removable housing between the secure long-term store and the banknote sensing means about the hinge such that the movement opens the validator to allow removal and replacement of the drive mechanism.

44. A banknote validator according to claim 41, wherein the removable casette unit comprises means for enabling rapid removal of the endless belt.

45. A banknote transport mechanism for use in conveying a banknote along a note path in a banknote validator, the mechanism comprising:
a resilient endless belt driven by a drive mechanism,
tensioning means for imparting a tension into the endless belt; and
gripping means for converting the tension in the endless belt to act as a banknote gripping force along different parts of the note path.

46. A mechanism according to claim 45, wherein the gripping means comprises deflection means for deflecting the belt from its natural position to provide the gripping force between the belt and reaction wheels of the transport mechanism such that the banknote can be gripped and transported along the note path.

47. A mechanism according to claim 46, wherein the deflection means is arranged to deflect the belt from its natural position to generate the gripping force at a direction substantially perpendicular to the movement of the belt in use along the note path.

48. A mechanism according to claim 46, wherein the deflection means is arranged to deflect the belt so as to generate a substantially constant gripping force along the portion of the note path where the banknote is to be gripped.

49. A mechanism according to claim 48, wherein the deflection means is curved along the note path to generate a constant gripping force.

50. A mechanism according to claim 48, wherein the deflection means comprises a curved guide surface along the note path of a banknote validator.

51. A mechanism according to claim 50, wherein the guide surface comprises a plurality of fixed reaction wheels against which the generated gripping force acts.

52. A mechanism according to claim 46, wherein the drive mechanism is provided in a removable cassette.

53. A mechanism according to claim 52, wherein a body portion of the cassette is shaped to accommodate deflection of the belt by the deflection means.

54. A mechanism according to claim 53, wherein the body portion is shaped to have a curved note path defining surface.

55. A mechanism according to claim 45, wherein the drive mechanism has two drive belt guide wheels.

56. A mechanism according to claim 55, wherein one of the drive wheels is a driven wheel and the other drive wheel is a reaction wheel.

57. A mechanism according to claim 55, wherein one of the drive wheels has a spring-loaded axis to provide the tensioning means and to enable removal of the belt when worn.

58. A mechanism according to claim 55, wherein the drive mechanism has a grooved belt and complementary grooved drive wheels for preventing lateral slippage of the belt off the drive wheels.

59. A banknote validator for receiving and accepting valid banknotes, the banknote validator including: a housing comprising a banknote attribute sensor; and a separable banknote drive mechanism for conveying the banknote into the validator to the banknote attribute sensor; wherein the banknote drive mechanism is arranged to be readily removable such that a faulty drive mechanism can be rapidly replaced, and the validator incorporates a banknote transport mechanism according to claim 45.

60. A method of creating a nip for gripping a sheet in a validator along a note path between a tensioned resilient band and fixed wheel at a discrete point along the note path, the method comprising tensioning the resilient band and deflecting the band from its natural course to generate a sheet gripping force.

61. A method of conveying a banknote along a note path in a banknote validator, the method comprising:
driving a resilient endless belt by use of a drive mechanism,
imparting a tension into the endless belt;
converting the tension in the endless belt to act as a banknote gripping force along parts of the note path.

62. A method according to claim 61, wherein the converting step comprises converting the tension in the belt to act as a substantially continuous gripping force along the note path.

63. A banknote validator housing comprising a sensor housing body and a sensor for sensing a characteristic of a banknote in use to determine its validity provided with the sensor housing body, wherein the sensor housing body comprises a one-piece translucent moulded portion defining a banknote-engaging surface along a note path of the validator and an opaque portion provided adjacent the sensor and arranged such that in use illumination of the banknote is sensed by the sensor without substantial interference from ambient light.

64. A banknote validator housing according to claim 63, wherein the opaque portion is provided facing away from the note path to prevent ambient light entering the validator and the translucent portion faces the note path.

65. A banknote validator housing according to claim 63, wherein the opaque portion has reflecting means provided within the body around a reflection or refraction or absorption light path from the banknote to the sensor.

66. A banknote validator housing according to claim 63, wherein the translucent portion has an optical element integrated within its structure.

67. A banknote validator housing according to claim 66, wherein the optical element comprises one of a group of optical elements comprising: a lens, a prism, a light guide and a reflection element.

68. A banknote validator housing according to claim 63, wherein the translucent portion and the opaque portions are secured together to form a removable cassette.

69. A banknote validator comprising a banknote validator housing according to claim 63.

70. A banknote validator for receiving and accepting valid banknotes, the banknote validator including: a housing according to claim 63, the housing comprising a banknote attribute sensor; and a separable banknote drive mechanism for conveying the banknote into the validator to the banknote attribute sensor; wherein the banknote drive mechanism is arranged to be readily removable such that a faulty drive mechanism can be rapidly replaced.

71. A banknote validator for receiving and accepting valid banknotes, the banknote validator including: a housing comprising banknote sensing means; and a separable banknote drive mechanism for conveying the banknote into the validator to the sensing means, wherein:
the banknote drive mechanism comprises a removable cassette unit which is arranged to be readily removable from the housing such that a faulty drive mechanism can be rapidly replaced;
the cassette unit comprises drive wheels and a drive belt; and
the housing comprises reaction wheels which react against the drive belt in use to grip banknotes.

72. A banknote validator for receiving and accepting valid banknotes, the banknote validator including: a housing comprising banknote sensing means; and a separable banknote drive mechanism for conveying the banknote into the validator to the sensing means; wherein the banknote drive mechanism comprises a removable cassette unit which is arranged to be readily removable from the housing such that a faulty drive mechanism can be rapidly replaced, and the cassette unit comprises an endless drive belt which defines a whole note path around the cassette.

73. A banknote validator for receiving and accepting valid banknotes, the banknote validator including: a non-removable housing comprising banknote sensing means; a secure long term store; and a separable banknote drive mechanism for conveying the banknote into the validator to the sensing means; wherein:
the banknote drive mechanism comprises a removable cassette unit which defines a note path from the validator to the long term store and is arranged to be readily removable from the housing such that a faulty drive mechanism can be rapidly replaced; and
one side of the cassette is provided adjacent the non-removable housing for guiding the banknote along the note path, and another side of the cassette is provided adjacent the secure long-term store such that banknotes are automatically released by reaching a note storage position along the note path.

74. A banknote validator according to claim 73, wherein the removable cassette unit comprises: two spaced apart endless belts which define the whole note path around the cassette; and means for enabling rapid removal of the endless belt from the cassette.

75. A banknote transport mechanism for use in conveying a banknote along a note path in a banknote validator, the mechanism comprising:
a resilient endless belt driven by a drive mechanism,
tensioning means for imparting a tension into the endless belt; and
gripping means for converting the tension in the endless belt to act as a banknote gripping force along different parts of the note path,
wherein the drive mechanism is provided in a removable cassette.

76. A mechanism according to claim 75, wherein the drive mechanism has two drive belt guide wheels.

77. A mechanism according to claim 76, wherein one of the drive wheels has a spring-loaded axis to provide the tensioning means and to enable removal of the belt from the cassette when worn.

78. A banknote transport mechanism for use in conveying a banknote along a note path in a banknote validator, the mechanism comprising:
a resilient endless belt driven by a drive mechanism,
tensioning means for imparting a tension into the endless belt; and
gripping means for converting the tension in the endless belt to act as a banknote gripping force along different parts of the note path;
wherein the drive mechanism is provided in a removable cassette and a body portion of the cassette is shaped to have a curved note path defining surface to accommodate deflection of the belt by the deflection means.

79. A banknote transport mechanism for use in conveying a banknote along a note path in a banknote validator, the mechanism comprising:
a resilient endless grooved belt driven by a drive mechanism, the drive mechanism being provided in a removable cassette and comprising two grooved drive wheels for preventing lateral slippage of the belt off the drive wheels;
tensioning means for imparting a tension into the endless belt; and
gripping means for converting the tension in the endless belt to act as a banknote gripping force along different parts of the note path;
wherein one of the drive wheels has a spring-loaded axis to provide the tensioning means and to enable removal of the belt from the drive wheels when worn.
